(19) United States
(12) Patent Application Publication
(10) Pub. No.: US 2024/0428624 A1
(43) Pub. Date: Dec. 26, 2024

(54) SERVER APPARATUS

(71) Applicant: TOYOTA JIDOSHA KABUSHIKI KAISHA, Toyota-shi (JP)

(72) Inventors: Yu NAGATA, Chofu-shi (JP); Shun HASHIMOTO, Kiyosu-shi (JP); Kota YAMAZAKI, Kasugai-shi (JP); Akane MASAKI, Nisshin-shi (JP); Wataru ETO, Nagoya-shi (JP); Makoto AKAHANE, Yokohama-shi (JP)

(73) Assignee: TOYOTA JIDOSHA KABUSHIKI KAISHA, Toyota-shi (JP)

(21) Appl. No.: 18/745,257

(22) Filed: Jun. 17, 2024

(30) Foreign Application Priority Data
Jun. 20, 2023 (JP) 2023-100924

(51) Int. Cl. G07C 5/00; H04W 4/029

(52) U.S. Cl. CPC G07C 5/008; G07C 5/006; H04W 4/029

(57) ABSTRACT

A server apparatus includes a communication interface configured to communicate with a terminal apparatus configured to request a service to dispatch a service staff or a service vehicle to a location in which a user vehicle is parked and supply an energy source to the user vehicle, and a controller configured to, upon receiving destination data indicating a destination from the terminal apparatus via the communication interface, select a parking location according to the destination indicated by the received destination data and a position of the service staff or the service vehicle, and transmit notification data prompting a user to park the user vehicle in the selected parking location to the terminal apparatus via the communication interface.

### CROSS-REFERENCE TO RELATED APPLICATION

This application claims priority to Japanese Patent Application No. 2023-100924 filed on Jun. 20, 2023, the entire contents of which are incorporated herein by reference.

### TECHNICAL FIELD

The present disclosure relates to a server apparatus.

### BACKGROUND

Patent Literature (PTL) 1 discloses a system to provide a service to charge vehicles on behalf of users and a service to dispatch power supply vehicles.

### CITATION LIST

### Patent Literature

PTL 1: JP 2020-107303 A
PTL 2: CN 109102105 A
PTL 3: CN 106157625 A

### SUMMARY

In a service to charge vehicles on behalf of users, it may take time to perform charging due to the absence of a nearby agent, depending on the parking positions of the vehicles to be charged. In a service to dispatch power supply vehicles, it may also take time to perform charging due to the absence of a nearby power supply vehicle, depending on the parking positions of the vehicles to be charged.

It would be helpful to reduce time taken to dispatch a service staff or a service vehicle.

A server apparatus according to the present disclosure includes:
a communication interface configured to communicate with a terminal apparatus configured to request a service to dispatch a service staff or a service vehicle to a location in which a user vehicle is parked and supply an energy source to the user vehicle; and
a controller configured to:
   upon receiving destination data indicating a destination from the terminal apparatus via the communication interface, select a parking location according to the destination indicated by the received destination data and a position of the service staff or the service vehicle; and
   transmit notification data prompting a user to park the user vehicle in the selected parking location to the terminal apparatus via the communication interface.

According to the present disclosure, time taken to dispatch a service staff or a service vehicle is reduced.

### BRIEF DESCRIPTION OF THE DRAWINGS

In the accompanying drawings:

FIG. 1 is a diagram illustrating a configuration of a service provision system according to an embodiment of the present disclosure;

FIG. 2 is a block diagram illustrating a configuration of a server apparatus according to the embodiment of the present disclosure;

FIG. 3 is a block diagram illustrating a configuration of a terminal apparatus according to the embodiment of the present disclosure; and

FIG. 4 is a flowchart illustrating operations of the service provision system according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

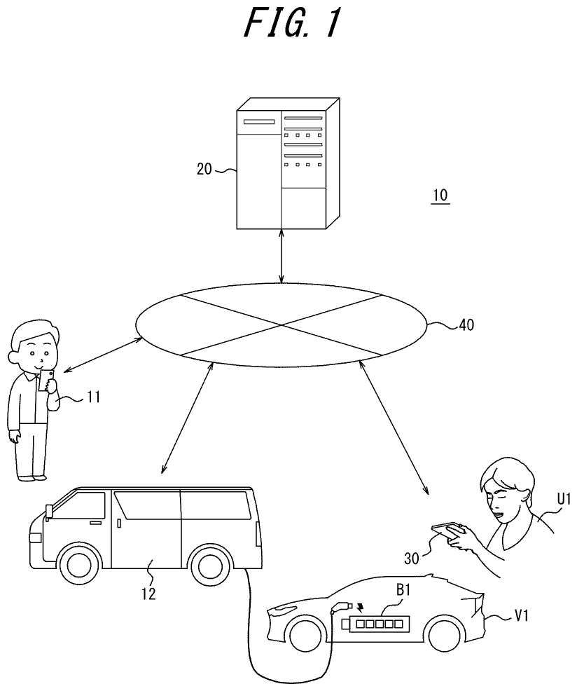

A configuration of a service provision system 10 according to the present embodiment will be described with reference to FIG. 1.

The service provision system 10 includes a server apparatus 20 and a terminal apparatus 30. The server apparatus 20 can communicate with the terminal apparatus 30 via a network 40. The server apparatus 20 may be able to communicate via the network 40 with a mobile device such as a mobile phone, smartphone, or tablet held by a service staff 11. The server apparatus 20 may be able to communicate via the network 40 with an in-vehicle device installed in a service vehicle 12 or a mobile device such as a mobile phone, smartphone, or tablet held by a staff on board the service vehicle 12. The terminal apparatus 30 may also be able to communicate via the network 40 with the mobile device held by the service staff 11, the in-vehicle device installed in the service vehicle 12, or the mobile device held by the staff on board the service vehicle 12.

The server apparatus 20 is a computer that belongs to a cloud computing system or other computing system installed in a facility such as a data center. The server apparatus 20 is operated by a supply service provider.

The terminal apparatus 30 is, for example, a mobile device such as a mobile phone, smartphone, or tablet held by each user. The terminal apparatus 30 executes a terminal program to request a supply service.

The supply service is a service to dispatch the service staff 11 or the service vehicle 12 to a location in which a user vehicle is parked and supply an energy source to the user vehicle. In the present embodiment, the user vehicle is a BEV. The term “BEV” is an abbreviation of battery electric vehicle. The energy source to be supplied to the user vehicle is electricity. As a variation of the present embodiment, the user vehicle may be another type of automobile such as a gasoline vehicle, a diesel vehicle, a hydrogen vehicle, an HEV, a PHEV, or an FCEV. The term “HEV” is an abbreviation of hybrid electric vehicle. The term “PHEV” is an abbreviation of plug-in hybrid electric vehicle. The term “FCEV” is an abbreviation of fuel cell electric vehicle. The user vehicle may be a MaaS-dedicated vehicle. The term “MaaS” is an abbreviation of Mobility as a Service. The energy source to be supplied to the user vehicle is not limited to electricity, and may be gasoline, diesel fuel, hydrogen, or the like.

The supply service includes at least a charging service or a battery replacement service, and includes both of the charging service and the battery replacement service in the present embodiment. The charging service is a service to supply the energy source to the user vehicle by charging a battery installed in the user vehicle. The battery replacement service is a service to supply the energy source to the user vehicle by replacing the battery installed in the user vehicle with another battery. As a variation of the present embodiment, the supply service may include a service to refuel the user vehicle.

The supply service includes at least an agent-type service or a mobile-type service, and includes both of the agent-type service and the mobile-type service in the present embodiment. The agent-type service is a service to dispatch the service staff 11 to the location in which the user vehicle is parked, have the dispatched service staff 11 move the user vehicle to another location, and supply the energy source to the user vehicle in the location to which the user vehicle is moved. The mobile-type service is a service to dispatch the service vehicle 12 to the location in which the user vehicle is parked and have the dispatched service vehicle 12 supply the energy source to the user vehicle in the location in which the user vehicle is parked.

In the present embodiment, one of the following combinations of services is selected by each user or automatically, and provided as the supply service: a combination of the charging service and the agent-type service, a combination of the battery replacement service and the agent-type service, a combination of the charging service and the mobile-type service, and a combination of the battery replacement service and the mobile-type service. In other words, in the present embodiment, the agent-type charging service, the agent-type battery replacement service, the mobile-type charging service, or the mobile-type battery replacement service is selectively provided.

For example, in the agent-type charging service, while a user U1 is not using a user vehicle V1, a worker as the service staff 11 drives the user vehicle V1 from a parking lot to a charging station, charges a battery B1 of the user vehicle V1, and then returns the user vehicle V1. In the agent-type battery replacement service, while the user U1 is not using the user vehicle V1, the worker as the service staff 11 drives the user vehicle V1 from the parking lot to a battery replacement station, replaces the battery B1 of the user vehicle V1 with another battery, and then returns the user vehicle V1. In the mobile-type charging service, a mobile charging vehicle as the service vehicle 12 comes to the parking lot, and charges the battery B1 of the user vehicle V1 on the spot. In the mobile-type battery replacement service, a mobile battery replacement vehicle as the service vehicle 12 comes to the parking lot, and replaces the battery B1 of the user vehicle V1 with another battery on the spot.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

Upon receiving destination data indicating a destination from the terminal apparatus 30, the server apparatus 20 selects a parking location according to the destination indicated by the received destination data and the position of the service staff 11 or the service vehicle 12. The server apparatus 20 transmits notification data prompting a user to park a user vehicle in the selected parking location to the terminal apparatus 30. Upon receiving the notification data from the server apparatus 20, the terminal apparatus 30 prompts the user to park the user vehicle in the parking location selected by the server apparatus 20 by presenting the received notification data to the user.

According to the present embodiment, time taken to dispatch the service staff 11 or the service vehicle 12 is reduced. As a result, labor and other costs associated with moving the service staff 11 or the service vehicle 12 can be reduced.

As an example, a user U1 is prompted to park a user vehicle V1 at a location selected according to the position of the worker as the service staff 11 from among multiple locations including not only the store parking lot but also other possible parking locations around the store, such as affiliated parking lots, when receiving the agent-type charging service while shopping. The position of the worker is not limited to the current location of the worker, and may be the position in which the worker, who is providing the service, should be at the end of the service provision. For example, suppose that a location close to the current location of the worker or a location close to where the worker is about to head to return another user vehicle whose batteries have been charged at a charging station is selected. Suppose that the user U1 parked the user vehicle V1 at the selected location, the worker would not have to travel for a long time to pick up the user vehicle V1. As a result, the cost of moving workers can be reduced. A location midway between the position of the user vehicle V1 and the position of the worker may be selected. Such an example would reduce the waiting time for the user U1 because the charging start time would be earlier. Alternatively, a location closer to the position of the worker may be selected, such as the parking lot of a store or the parking lot of another store in the same family, which is a different location from the destination but can achieve the same purpose as that achieved at the destination. Such an example would reduce time taken until the user U1 achieves a purpose such as shopping after parking the user vehicle V1.

As another example, a user U1 is prompted to park a user vehicle V1 at a location selected according to the position of the mobile charging vehicle as the service vehicle 12 from among multiple locations including not only the store parking lot but also other possible parking locations around the store, such as affiliated parking lots, when receiving the mobile-type charging service while shopping. The position of the mobile charging vehicle is not limited to the current location of the mobile charging vehicle, and may be the position in which the mobile charging vehicle, which is providing the service, should be at the end of the service provision. For example, suppose that a location near the current location of the mobile charging vehicle or a location near where the mobile charging vehicle has charged the battery of another user vehicle is selected. Suppose that the user U1 has parked the user vehicle V1 at the selected location, the mobile charging vehicle would not have to travel for a long time to reach the vicinity of user vehicle V1. As a result, the cost of moving mobile charging vehicles can be reduced. A location midway between the position of the user vehicle V1 and the position of the mobile charging vehicle may be selected. Such an example would reduce the waiting time for the user U1 because the charging start time would be earlier. Alternatively, a location closer to the position of the mobile charging vehicle may be selected, such as the parking lot of a store or the parking lot of another store in the same family, which is a different location from the destination but can achieve the same purpose as that achieved at the destination. Such an example would reduce time taken until the user U1 achieves a purpose such as shopping after parking the user vehicle V1.

The user U1 may be presented a fee for requesting charging during the daytime and a fee for requesting charging late at night, when electricity costs are lower but labor costs are higher. Alternatively, the lowest fee may be presented to the user U1. The user U1 can adjust the time of day to request charging with reference to the fee presented.

The case in which the user U1 receives the agent-type battery replacement service is the same as the case in which the user U1 receives the agent-type charging service. The case in which the user U1 receives the mobile-type battery replacement service is the same as the case in which the user U1 receives the mobile-type charging service.

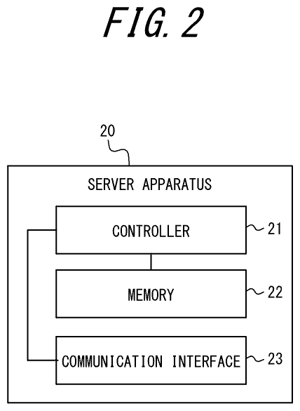

A configuration of the server apparatus 20 according to the present embodiment will be described with reference to FIG. 2.

The server apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the server apparatus 20 while controlling components of the server apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores data to be used for operations of the server apparatus 20 and data obtained by the operations of the server apparatus 20.

The communication interface 23 includes at least one communication module. The communication module is, for example, a module compatible with a wired LAN communication standard such as Ethernet® (Ethernet is a registered trademark in Japan, other countries, or both) or a wireless LAN communication standard such as IEEE802.11. The name “IEEE” is an abbreviation of Institute of Electrical and Electronics Engineers. The communication interface 23 communicates with the terminal apparatus 30. The communication interface 23 may communicate with the mobile device held by the service staff 11. The communication interface 23 may communicate with the in-vehicle device installed in the service vehicle 12 or the mobile device held by the staff on board the service vehicle 12. The communication interface 23 receives data to be used for the operations of the server apparatus 20, and transmits data obtained by the operations of the server apparatus 20.

The functions of the server apparatus 20 are realized by execution of a server program according to the present embodiment by a processor serving as the controller 21. That is, the functions of the server apparatus 20 are realized by software. The server program causes a computer to execute the operations of the server apparatus 20, thereby causing the computer to function as the server apparatus 20. That is, the computer executes the operations of the server apparatus 20 in accordance with the server program to thereby function as the server apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the server apparatus 20 may be realized by a programmable circuit or a dedicated circuit serving as the controller 21.

That is, some or all of the functions of the server apparatus 20 may be realized by hardware.

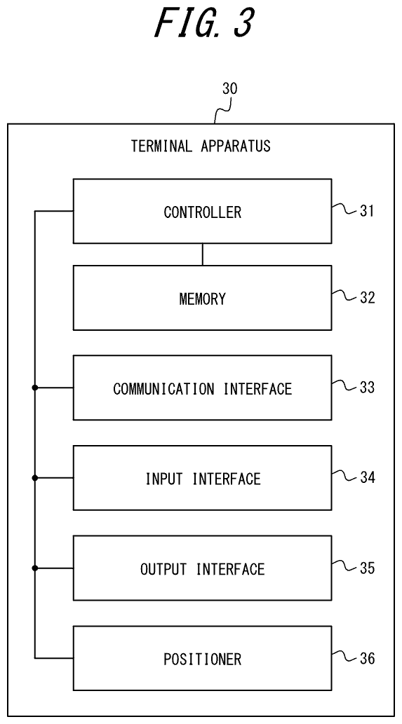

A configuration of the terminal apparatus 30 according to the present embodiment will be described with reference to FIG. 3.

The terminal apparatus 30 includes a controller 31, a memory 32, a communication interface 33, an input interface 34, an output interface 35, and a positioner 36.

The controller 31 includes at least one processor, at least one programmable circuit, at least one dedicated circuit, or any combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the terminal apparatus 30 while controlling components of the terminal apparatus 30.

The memory 32 includes at least one semiconductor memory, at least one magnetic memory, at least one optical memory, or any combination thereof. The semiconductor memory is, for example, RAM, ROM, or flash memory. The RAM is, for example, SRAM or DRAM. The ROM is, for example, EEPROM. The flash memory is, for example, SSD. The magnetic memory is, for example, HDD. The memory 32 functions as, for example, a main memory, an auxiliary memory, or a cache memory. The memory 32 stores data to be used for the operations of the terminal apparatus 30 and data obtained by the operations of the terminal apparatus 30.

The communication interface 33 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The communication interface 33 communicates with the server apparatus 20. The communication interface 33 may communicate with the mobile device held by the service staff 11. The communication interface 33 may communicate with the in-vehicle device installed in the service vehicle 12 or the mobile device held by the staff on board the service vehicle 12. The communication interface 33 receives data to be used for the operations of the terminal apparatus 30, and transmits data obtained by the operations of the terminal apparatus 30.

The input interface 34 is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 34 accepts an operation for inputting data to be used for the operations of the terminal apparatus 30. The input interface 34, instead of being included in the terminal apparatus 30, may be connected to the terminal apparatus 30 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 35 is, for example, a display or a speaker. The display is, for example, an LCD or an organic EL display. The term “LCD” is an abbreviation of liquid crystal display. The term “EL” is an abbreviation of electro luminescent. The output interface 35 outputs data obtained by the operations of the terminal apparatus 30. The output interface 35, instead of being included in the terminal apparatus 30, may be connected to the terminal apparatus 30 as an external output device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The positioner 36 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 36 measures the position of the terminal apparatus 30.

The functions of the terminal apparatus 30 are realized by execution of the terminal program according to the present embodiment by a processor serving as the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a programmable circuit or a dedicated circuit serving as the controller 31. That is, some or all of the functions of the terminal apparatus 30 may be realized by hardware.

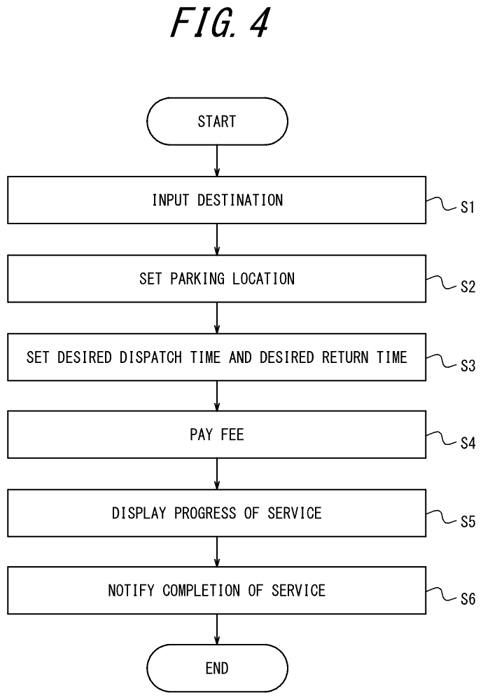

With reference to FIG. 4, operations of the service provision system 10 according to the present embodiment will be described. The operations described below correspond to a service provision method according to the present embodiment. In other words, the service provision method according to the present embodiment includes steps S1 through S6 illustrated in FIG. 4.

When a user U1 starts the terminal program to request the supply service or selects a specific item such as “request service” on a menu screen of the terminal program, step S1 is executed.

In S1, upon accepting, via the input interface 34, a first user operation to specify a destination, the controller 31 of the terminal apparatus 30 transmits destination data to the server apparatus 20 via the communication interface 33. The destination data is data indicating the destination specified by the first user operation. The destination is, for example, a store such as a convenience store. The controller 21 of the server apparatus 20 receives the destination data from the terminal apparatus 30 via the communication interface 23.

In S2, the controller 21 of the server apparatus 20 receives positional data via the communication interface 23 from the mobile device held by the service staff 11, the in-vehicle device installed in the service vehicle 12, or the mobile device held by the staff on board the service vehicle 12. The positional data is data indicating the position of the service staff 11 or the service vehicle 12. The position of the service staff 11 is not limited to the current position of the service staff 11, and may be the position in which the service staff 11, who is in operation, should be after the service provision. Similarly, the position of the service vehicle 12 is not limited to the current position of the service vehicle 12, and may be the position in which the service vehicle 12, which is in operation, should be after the service provision. The controller 21 of the server apparatus 20 selects a parking location according to the destination indicated by the destination data received in S1 and the position indicated by the received positional data. Specifically, the controller 21 of the server apparatus 20 selects the parking location from among one or more locations within a geographical area that is based on the destination indicated by the destination data, according to the closeness from the position indicated by the positional data. For example, the controller 21 of the server apparatus 20 selects the location that is the closest to the position of the service staff 11 or the service vehicle 12 from among the destination and points around the destination as the parking location. Alternatively, the controller 21 of the server apparatus 20 may select a location for which the difference between the closeness from the position of the user vehicle V1 and the closeness from the position indicated by the positional data is equal to or less than a threshold, as the parking location. For example, the controller 21 of the server apparatus 20 may select a location midway between the position of the user vehicle V1 and the position of the service staff 11 or the service vehicle 12 as the parking location. Alternatively, in a case in which the destination is not within a geographical area that is based on the position indicated by the positional data, the controller 21 of the server apparatus 20 may select a location in which the same purpose as that in a case of having traveled to the destination can be achieved, as the parking location, from among one or more locations within the geographical area. For example, suppose that the destination is a store, the controller 21 of the server apparatus 20 may select the parking lot that is the closest to the position of the service staff 11 or the service vehicle 12 among the parking lots of the store and another store in the same family as the destination, as the parking location. The controller 21 of the server apparatus 20 transmits notification data to the terminal apparatus 30 via the communication interface 23. The notification data is data prompting the user U1 to park the user vehicle V1 in the selected parking location. Upon receiving the notification data from the server apparatus 20 via the communication interface 33, the controller 31 of the terminal apparatus 30 prompts the user U1 to park the user vehicle V1 in the parking location selected by the server apparatus 20 by presenting the notification data to the user U1 such as by displaying the notification data on a display serving as the output interface 35.

In S3, the controller 31 of the terminal apparatus 30 accepts, via the input interface 34, a second user operation to input a desired dispatch time and a desired return time. The desired dispatch time corresponds to the time when the service staff 11 picks up the user vehicle V1, as desired by the user U1 in the case of the agent-type service. The desired dispatch time corresponds to the time when the service vehicle 12 arrives in the vicinity of the user vehicle V1, as desired by the user U1 in the case of the mobile-type service. The desired return time corresponds to the time when the service staff 11 returns the user vehicle V1 after charging or battery replacement, as desired by the user U1 in the case of the agent-type service. The desired return time corresponds to the time when the service vehicle 12 completes charging or battery replacement of the user vehicle V1, as desired by the user U1 in the case of the mobile-type service.

In S4, upon accepting, via the input interface 34, a third user operation to pay for the supply service, the controller 31 of the terminal apparatus 30 transmits request data to the server apparatus 20 via the communication interface 33. The request data is data requesting the supply service. In the present embodiment, the request data includes data indicating the desired dispatch time and the desired return time input by the second user operation in S3. Upon receiving the request data from the terminal apparatus 30 via the communication interface 23, the controller 21 of the server apparatus 20 automatically processes payment for the supply service according to the received request data. Once the automatic process of payment is completed, the controller 21 of the server apparatus 20 performs a process of dispatching the service staff 11 or the service vehicle 12 to the parking location selected in S2. Specifically, the controller 21 of the server apparatus 20 notifies, of the parking location, the desired dispatch time and the desired return time, and other information, a manager who dispatches the service staff 11 or the service vehicle 12 to the parking location. Alternatively, the controller 21 of the server apparatus 20 may dispatch a worker as the service staff 11 to the parking location by transmitting first instruction data via the communication interface 23 to a mobile device held by the worker. Alternatively, the controller 21 of the server apparatus 20 may dispatch a mobile charging vehicle as the service vehicle 12 to the parking location by transmitting second instruction data via the communication interface 23 to an in-vehicle device installed in the mobile charging vehicle or a mobile device held by a worker on board the mobile charging vehicle. Alternatively, the controller 21 of the server apparatus 20 may dispatch a mobile battery replacement vehicle as the service vehicle 12 to the parking location by transmitting third instruction data via the communication interface 23 to an in-vehicle device installed in the mobile battery replacement vehicle or a mobile device held by a worker on board the mobile battery replacement vehicle. The first instruction data is data that instructs the worker to provide the agent-type charging service. Alternatively, the first instruction data may be data that instructs the worker to provide the agent-type battery replacement service. The second instruction data is data that instructs the mobile charging vehicle or the worker on board the mobile charging vehicle to provide the mobile-type charging service. The third instruction data is data that instructs the mobile battery replacement vehicle or the worker on board the mobile battery replacement vehicle to provide the mobile-type battery replacement service. The first, second, and third instruction data may include the parking location, the desired dispatch time and the desired return time, and other information.

In S5, the controller 21 of the server apparatus 20 monitors the progress of the supply service. When the type of the supply service requested in S4 is the agent-type charging service or the agent-type battery replacement service, the controller 21 of the server apparatus 20 monitors the progress by communicating via the communication interface 23 with the mobile device held by the worker. When the type of the supply service requested in S4 is the mobile-type charging service, the controller 21 of the server apparatus 20 monitors the progress by communicating via the communication interface 23 with the in-vehicle device installed in the mobile charging vehicle or the mobile device held by the worker on board the mobile charging vehicle. When the type of the supply service requested in S4 is the mobile-type battery replacement service, the controller 21 of the server apparatus 20 monitors the progress by communicating via the communication interface 23 with the in-vehicle device installed in the mobile battery replacement vehicle or the mobile device held by the worker on board the mobile battery replacement vehicle. The controller 21 of the server apparatus 20 notifies the terminal apparatus 30 of the progress via the communication interface 23. The controller 31 of the terminal apparatus 30 displays the progress to the display as the output interface 35.

In S6, upon detecting completion of the supply service, the controller 21 of the server apparatus 20 notifies the terminal apparatus 30 of the completion via the communication interface 23. The controller 31 of the terminal apparatus 30 displays a screen indicating that the supply service has been completed, on the display as the output interface 35. In this screen, when the type of the supply service requested in S4 is the agent-type charging service or the agent-type battery replacement service, information regarding a position in which the worker has parked the user vehicle V1 may be displayed. A photograph of the user vehicle V1 taken by the worker may be displayed.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. A server apparatus comprising:
a communication interface configured to communicate with a terminal apparatus configured to request a service to dispatch a service staff or a service vehicle to a location in which a user vehicle is parked and supply an energy source to the user vehicle; and
a controller configured to:
upon receiving destination data indicating a destination from the terminal apparatus via the communication interface, select a parking location according to the destination indicated by the received destination data and a position of the service staff or the service vehicle; and
transmit notification data prompting a user to park the user vehicle in the selected parking location to the terminal apparatus via the communication interface.

2. The server apparatus according to claim 1, wherein the controller is configured to select the parking location from among one or more locations within a geographical area that is based on the destination, according to closeness from the position of the service staff or the service vehicle.

3. The server apparatus according to claim 1, wherein the controller is configured to select a location for which a difference between closeness from a position of the user vehicle and closeness from the position of the service staff or the service vehicle is equal to or less than a threshold, as the parking location.

4. The server apparatus according to claim 1, wherein the position of the service staff or the service vehicle is a position in which a service staff who is in operation should be after a service provision or a position in which a service vehicle that is in operation should be after a service provision.

5. The server apparatus according to claim 1, wherein the controller is configured to, in a case in which the destination is not within a geographical area that is based on the position of the service staff or the service vehicle, select a location in which a same purpose as that in a case of having traveled to the destination can be achieved, as the parking location, from among one or more locations within the geographical area.
